(19) United States
(12) Patent Application Publication
(10) Pub. No.: US 2008/0226068 A1
(43) Pub. Date: Sep. 18, 2008

(54) Scrambling for Anonymous Visual Communication

(76) Inventors: Frederic A. Dufaux, Bois D'Amont (FR); Ebrahimi Touradj, Pully (CH)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(21) Appl. No.: 11/995,139

(22) PCT Filed: Jul. 31, 2006
(86) PCT No.: PCT/IB2006/002083

§ 371 Date: May 5, 2008

Related U.S. Application Data
(60) Provisional application No. 60/595,734, filed on Aug. 1, 2005.

(51) Int. Cl. H04N 7/167

(52) U.S. Cl. 380/217; 380/210

(57) ABSTRACT

A video communication system is disclosed which allows one or more of the participants to selectively participate anonymously by scrambling regions of the video of arbitrary shape, such as the face of the participant. Initially, the video content is analyzed to locate an arbitrary shape of interest, such as a human face or part of a human body. Once the region of interest is located, it is scrambled, for example, in conjunction with two well known video coding schemes; MPEG-4 and Motion JPEG-2000. The arbitrary regions can be scrambled in the image-domain prior to coding, in the transform-domain during coding, or in the bit stream domain after coding.

### CROSS REFERENCE TO RELATED APPLICATIONS

This application claims priority to and the benefit of U.S. Provisional Patent Application No. 60/595,734, filed on Aug. 1, 2005, hereby incorporated by reference.

### BACKGROUND OF THE INVENTION

1. Field of the Invention

The present invention relates to a visual communication system, and more particularly to a visual communication system, such as video conferencing, video telephony and Internet video chat, that selectively allows participants to participate anonymously.

2. Description of the Prior Art

Various video communication systems are known in the art. As used herein, such video communication systems are defined to include video conferencing, video telephony and Internet video chat systems which are capable of one and two way communication of live video content between two or more participants. Examples of such video communication systems in U.S. Pat. Nos. 5,550,754; 5,867,494; 6,205,177; 6,249,318; 6,560,284; 6,608,636; 6,665,389; and 6,909,708 as well as US Patent Application Publication Nos. US 2002/0049616 A1; US 2004/0008249 A1; and US 2004/0008635 A1, all hereby incorporated by reference.

Such video communication systems are known to be used in a myriad of applications. For example, chat rooms are very popular on the Internet. Besides its ease and convenience to communicate, part of its appeal resides in the anonymity it provides. Thanks to technological advances, many chat room applications, such as Yahoo Messenger and MSN Messenger, now offer the possibility of a video link in order to enhance the communication. The video provides a desirable sense of human contact. Other applications include video conferencing as described in detail in U.S. Pat. No. 5,867,494 and US Patent Application Publication No. US 2004/0008635 A1, hereby incorporated by reference. U.S. Pat. No. 6,665,389 B1 discloses the use of video conferencing for an interactive dating service.

In some applications, it may be necessary for one of the participants to the video communication to be anonymous. For example, participants in the interactive dating service may choose to initially be anonymous. In addition, certain news sources may wish to remain anonymous. U.S. Pat. No. 6,665,389 and US Patent Application Publication No. US 2004/0008635 A1 have attempted to resolve this problem. Unfortunately, the solution is to totally block the video portion of the communication, which defeats the purpose of the video communication. Thus, there is a need for a video communication system which allows one or more of the participants to selectively participate in a video communication without defeating the purpose of the video communication system.

### SUMMARY OF THE INVENTION

The present invention relates to a video communication system which allows one or more of the participants to selectively participate anonymously by scrambling regions of the video of arbitrary shape, such as the face of the participant. Initially, the video content is analyzed to locate an arbitrary shape of interest, such as a human face or part of a human body. Once the region of interest is located, it is scrambled, for example, in conjunction with two well known video coding schemes; MPEG-4 and Motion JPEG-2000. The arbitrary regions can be scrambled in the image-domain prior to coding, in the transform-domain during coding, or in the bit stream domain after coding.

### DESCRIPTION OF THE DRAWING

These and other advantages of the present invention will be readily understood with reference to the following specification and attached drawing wherein:

FIG. 1 is a generalized block diagram of the processing steps utilized in the present invention.

FIG. 2 is a block diagram of image domain scrambling in accordance with one embodiment of the invention.

FIG. 3 is a diagram illustrating bit plane scrambling in accordance with the present invention.

FIG. 4 is a block diagram of transform domain scrambling in accordance with an alternate embodiment of the invention.

FIG. 5 is a diagram illustrating transform domain scrambling.

FIG. 6 is a diagram illustrating wavelet scrambling.

FIG. 7 is a block diagram of bit stream domain scrambling in accordance with another alternate embodiment of the invention.

### DETAILED DESCRIPTION

The present invention relates to a video communication system which allows one or more of the participants to selectively participate anonymously by scrambling regions of the video of arbitrary shape, such as the face of the participant. Initially, the video content is analyzed to locate an arbitrary shape of interest, such as a human face or part of a human body. Once the region of interest is located, it is scrambled, for example, in conjunction with two well known video coding schemes; MPEG-4 and Motion JPEG-2000. The MPEG-4 coding scheme is is described in detail in “The MPEG-4 Book”, Prentice Hall, by Ebrahimi and Pereira, 2002, hereby incorporated by reference. The Motion JPEG 2000 coding scheme is described in detail in “The JPEG 2000 Still Image Compression Standard” by Skodras et al, IEEE Signal Processing Magazine, vol. 18, no. 5, pp. 36-58, September 2001 and “JPEG 2000: Image Compression Fundamentals, Standards and Practice” Kluwer Academic Publishers 2002, both hereby incorporated by reference. The arbitrary regions can be scrambled in the image-domain prior to coding, in the transform-domain during coding, or in the bit stream domain after coding.

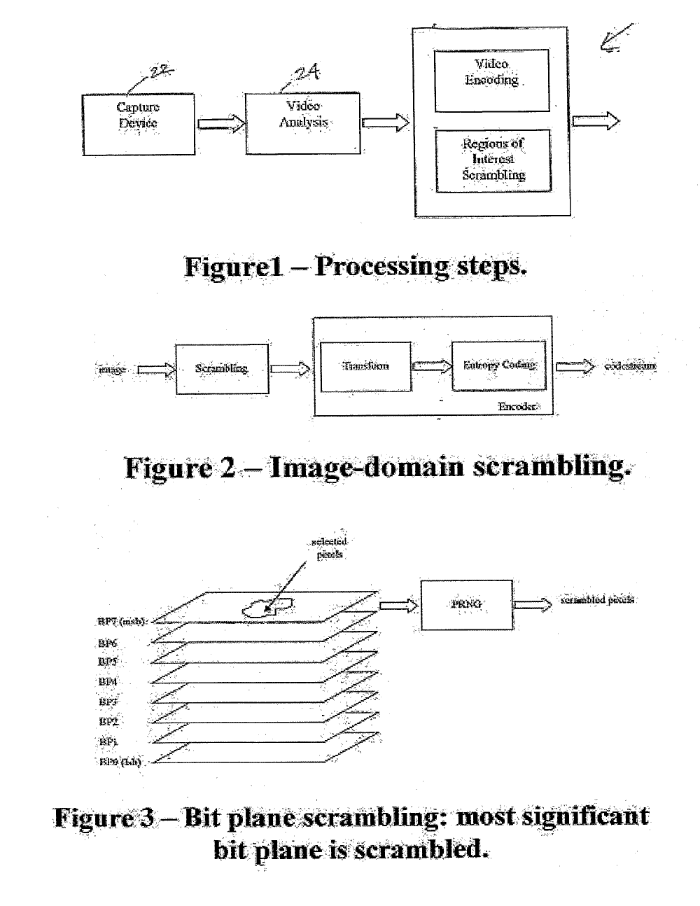

Referring first to FIG. 1, the video communication system in accordance with the present invention is generally identified with the reference numeral 20. The video communication system 20 includes a video capture device 22, a video analysis application and a video encoding application 26.

The video content for each participant in the video communication system 20 is first acquired by the video capture device 22, for example, a visible spectrum, near-infrared or infrared camera. The near infrared and infrared cameras allow for low light applications without additional lighting. The video capture device 22 may also be a relatively low cost conventional web cam, for example, a Quick Cam Pro 4000, as manufactured by Logitech. Such conventional web cams come with standard software for capturing and storing video content on a frame by frame basis. Virtually any video capture device 22 is suitable for this purpose.

In accordance with one aspect of the invention, only portions of the video content are scrambled by a video analysis application running on a PC (not shown), such as a standard laptop PC with a 2.4 GHz Pentium processor. In accordance with an important aspect of the invention, the system analyzes the video content to identify arbitrary shapes in a video frame, such as a human face or human skin and only scrambles the arbitrary shapes. Various application programs are suitable for identifying human faces in a video frame, such as International Publication No. WO 2006/070249 A1, published on Jul. 6, 2006 and WO 2006/006081 A2, published on Jan. 19, 2006; “Neural Network Based Face Detection” by Rowley et al, IEEE Transactions On PAMI, vol. 20, no. 1, pp. 23-38, 1998; and “Rapid Object Detection Using a Boosted Cascade of Simple Features” by Viola et al, IEEE Proceedings CVPR, Hawaii, December 2001, all hereby incorporated by reference. Other conventional applications may also be suitable Detection of human skin is also known in the art. for example, as disclosed in “Statistical Color Models With Applications to Skin Detection” by Jones et al, TR 98-11, CRL, Compaq Computer Corp. December 1998 and “Optimum Color Spaces for Skin Detection” by Albiol et al, IEEE Proc. Inter. Conf. on Image Proc., Thessaloniki, Greece, October 2001, hereby incorporated by reference. Once the regions of interest of a video frame are identified, the video frame is encoded by conventional video coding techniques, such as MPEG-4 and Motion JPEG 2000 and the regions of interest are scrambled by the video encoding application 26 in accordance with the present invention. Scrambling is closely linked to the scheme used to encode the video. Many known video coding schemes are based on transform-coding. Namely, frames are transformed using an energy compaction transform such as the Discrete Cosine Transform (DCT) or wavelet transform, which are known in the art. The resulting coefficients are then entropy coded using known techniques, such as Huffman or arithmetic coding.

In order to the resulting segmentation mask, a morphological filter may be applied. More specifically, small regions and holes are removed in the segmentation mask by opening (i.e. erosion followed by dilation) then a closing (i.e. dilation followed by erosion). A suitable morphological filter is disclosed in “Flat Zones Filtering, Connected Operators and Filters by Reconstruction” by Salembier et al, IEEE Transactions on Image Processing, vol. 3, no. 8, pp. 1153-1160, August 1995, hereby incorporated by reference.

In accordance with the present invention, two well-known video coding schemes are contemplated: MPEG-4 and Motion JPEG 2000. MPEG-4 is based on a motion compensated block-based DCT. Motion JPEG 2000 is an extension of JPEG 2000 for the coding of video sequences. It consists of the intra-frame coding of each frame using wavelet-based JPEG 2000. Basically, scrambling can be applied at three different stages: in the image-domain prior to coding, in the transform-domain during coding, or in the bit stream-domain after coding.

FIG. 2 illustrates image domain processing. With this approach, the region of interest in the original image is scrambled prior to encoding. This can be achieved by randomly flipping the most significant bit plane of the pixels belonging to the region to be scrambled using a pseudo-random number generator (PRNG), as shown in FIG. 3. This approach has the advantage of being very simple and independent from the encoding scheme subsequently used. However, it has the disadvantage of introducing noise in the image prior to coding, possibly leading to lower coding performance. Note that the same effect could be achieved to some extend by masking the pixels corresponding to the regions of interest (e.g. replacing them by a given color), or by applying a low-pass filter (e.g. making the regions sufficiently blurred). However, these two approaches have the drawback to preclude the possibility to ever unscramble the video, which may be a desirable feature in some applications. In addition, the masking approach provides an all-or-nothing solution without flexibility to control the amount of distortion introduced.

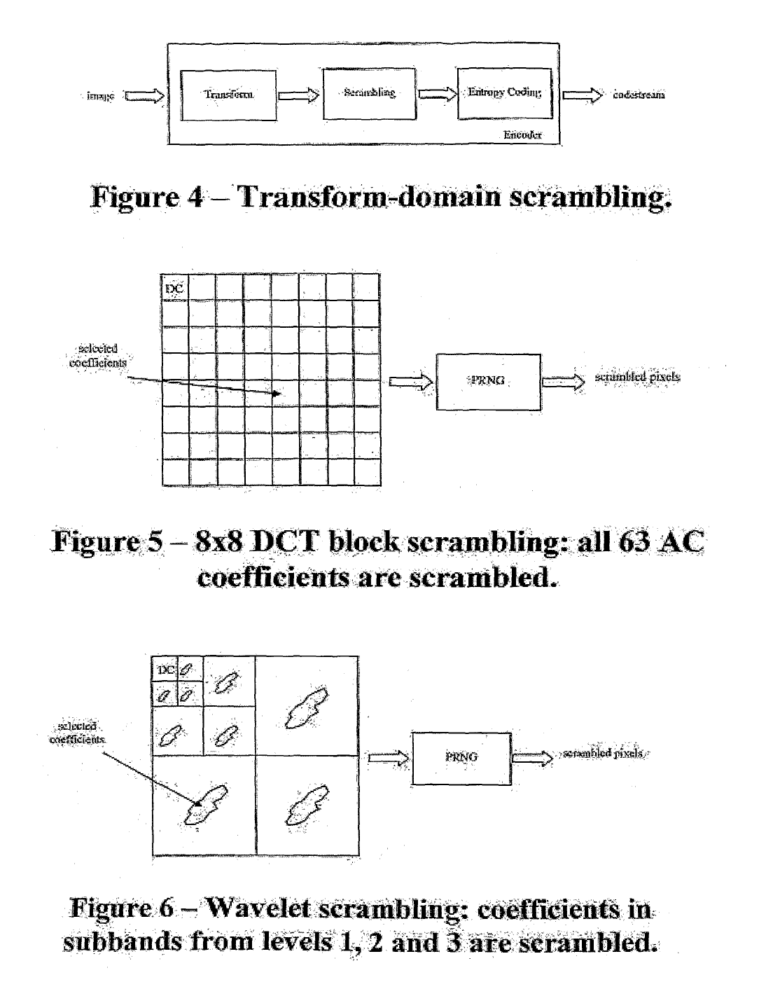

A second approach is to apply scrambling during encoding, as shown in FIG. 4. In this embodiment, scrambling is taking place after the DCT or wavelet transform and before entropy coding. More specifically, the sign of transform coefficients are randomly flipped corresponding to the region to be scrambled. Besides its simplicity, this approach does not adversely affect the subsequent entropy coding. Furthermore, thanks to the frequency analysis property of the transform, the strength of the scrambling can be controlled by restricting the scrambling to some frequencies.

In the application of MPEG-4, each frame is subdivided in 16×16 MacroBlocks (MB). Each MB is composed of four 8×8 luminance blocks and two 8×8 chrominance blocks. The DCT is performed on these 8×8 blocks, resulting in 64 DCT coefficients: one DC and 63 AC coefficients. In this application, all the blocks corresponding to the regions to be scrambled are identified. For these blocks, all 63 AC coefficients are scrambled as illustrated in FIG. 5. A psuedo random noise generator (PRNG) is then used to randomly inverse their sign. It would be possible to scramble fewer AC coefficients; however it may no longer be sufficient to effectively hide the content of the regions of interest.

Note that for the MPEG-4 case, the shape of the scrambled regions is restricted to match the 8×8 DCT blocks boundaries. It can also be pointed out that the same technique could be used for the DCT-based JPEG. The technique is similar in the case of Motion JPEG 2000. Wavelet coefficients belonging to the AC sub-bands and corresponding to the region to be scrambled have their sign randomly flipped, as shown in FIG. 6. For example, assume an image decomposed with 3 resolution levels. Scrambling coefficients in all AC sub-bands, i.e. levels 1, 2 and 3, results in a strong scrambling. Subsequently, as previously a PRNG is used to randomly inverse the sign of the corresponding coefficients. The amount of scrambling could be decreased by restricting the scrambling to fewer resolution levels; however it may no longer effectively hide the regions of interest. Unlike the MPEG-4 case, with Motion JPEG 2000 the scrambled regions can have an arbitrary shape.

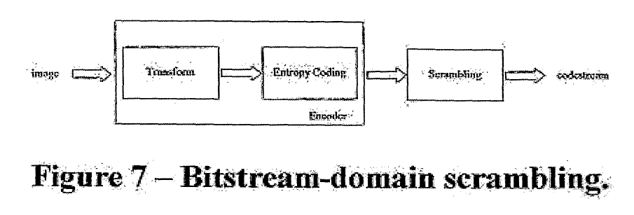

In the third approach, scrambling is applied after encoding, as illustrated in FIG. 7. More specifically, the compressed bit stream is directly scrambled. Again, this can be efficiently done by pseudo-randomly flipping bits in the stream. One of the drawbacks of this approach is that the bit stream has to be parsed in order to identify which parts correspond to the region to be scrambled. Furthermore, it may be difficult to adjust the strength of the scrambling. Finally, another severe drawback is that the scrambled bit stream may crash the decoder.

Obviously, many modifications and variations of the present invention are possible in light of the above teachings. Thus, it is to be understood that, within the scope of the appended claims, the invention may be practiced otherwise than as specifically described above.

What is claimed and desired to be secured by a Letters Patent of the United States is:

We claim:

1. A method for selectively scrambling regions of interest during video communication, the system comprising:
(a) capturing video content by way of a video capture device;
(b) analyzing said captured video content to determine a region of interest;
(c) scrambling said regions of interest; and
(d) encoding said video content for transport over a network.

2. The method as recited in claim 1, wherein step (c) comprises:
(c) scrambling said regions of interest in the image domain before said encoding step.

3. The method as recited in claim 1, wherein step (c) comprises:
(c) scrambling said regions of interest in the transform domain during said encoding step.

4. The method as recited in claim 1, wherein step (c) comprises:
(c) scrambling said regions of interest in the code stream domain after said encoding step.

5. The method as recited in claim 1, wherein step (d) includes the step of encoding by known video encoding techniques.

6. The method as recited in claim 5, wherein step (d) includes the step of encoding includes encoding by MPEG-4 video encoding techniques.

7. The method as recited in claim 5, wherein step (d) includes the step of encoding includes encoding by Motion JPEG-2000 video encoding techniques.

8. A system for selectively scrambling regions of interest during video communication, the system comprising:
(a) a video capture device for capturing video content a video capture device;
(b) a system for analyzing said captured video content to determine a region of interest;
(c) a scrambling system for scrambling said regions of interest; and
(d) an encoding system for encoding said video content for transport over a network.

9. The system as recited in claim 8, wherein said scrambling system scrambles said regions of interest in the image domain before encoding.

10. The system as recited in claim 8, wherein scrambling system scrambles said regions of interest in the transform domain during said encoding.

11. The system as recited in claim 8, wherein said scrambling system scrambles said regions of interest in the code stream domain after said encoding.

12. The system as recited in claim 8, wherein said encoding system encodes said captured video content by known video encoding techniques.

13. The method as recited in claim 12, wherein said known video coding technique is MPEG-4.

14. The system as recited in claim 12, wherein said known video coding technique is Motion JPEG-2000.
